(19) United States
(12) Patent Application Publication
(10) Pub. No.: US 2010/0257744 A1
(43) Pub. Date: Oct. 14, 2010

(54) Apparatus and Method for Extending the Useful Life of a Cutting Edge Tool

(76) Inventor: Randy S. Malkewich, Calgary (CA)

Correspondence Address: WILLIAM J BUNDREN;THE LAW OFFICE OF WILLIAM J BUNDREN, 734 LaRue Road, Millersville, MD, 21108, US

(21) Appl. No.: 12/761,260

(22) Filed: Apr. 15, 2010

Related U.S. Application Data
(63) Continuation-in-part of application No. 11/421,124, filed on May 31, 2006, now abandoned.

(30) Foreign Application Priority Data
May 31, 2005 (CA) 2508643

(51) Int. Cl. B26B 21/40

(52) U.S. Cl. 30/538

(57) ABSTRACT

An apparatus and method for extending the useful life of a cutting edge of a cutting edge tool is provided. The apparatus comprises a housing for supporting a cutting edge tool such as a shaving razor. Disposed within the housing can be at least one metal member that is positioned underneath or in proximity to the cutting edge of the tool. The metal member can comprise a plurality of upward facing protrusions configured in a grid pattern. The method comprises providing a housing containing the metal member, and placing a cutting edge tool on the housing such that the cutting edge is positioned in proximity to the metal member. It is observed that placing a cutting edge tool on the apparatus can prevent or inhibit oxidation from forming on the cutting edge, thereby extending the cutting tool's useful life.

### TECHNICAL FIELD

The present disclosure relates to the field of apparatuses and methods for extending the useful life of cutting edges of cutting edge tools, in particular, shaving razors and the like.

### BACKGROUND

Cutting edge tools lose their sharpness (or degrade) as a result of a number of factors including the use of the tool. In many applications, a sharp cutting edge is desirable and safer to use. Examples of cutting edges and their applications include, without limitation, a razor blade, a knife blade, scissors, sharp or honed edges on any number of tools, e.g., cutting tools, garden tools, construction tools, etc. Exemplary tools that include a cutting edge include but are not limited to a manual razor, an electric razor, any knife; garden tools; such as a shovel, hoe, and/or machete; and construction tools, such as a cutting knife or utility knife, a drill bit, a screw driver (e.g., slotted or Phillips), a chisel, and/or a putty knife. For cutting tools exposed to moisture during or after their use, especially those made of iron or steel, corrosion or degradation can occur on the cutting edge and shorten the useful life of the cutting edge.

Steel, particularly razor steel, is susceptible to corrosion, rust, and/or degradation. Typically, this corrosion occurs when the steel or cutting edge comes into contact with moisture, water or air, which in turn promotes oxidation on the surface of the steel. For example, razor steel is a form of stainless steel that may be comprised of an alloy of iron and chromium (e.g., consisting of approximately 85% iron and approximately 15% chromium). As well known to those skilled in the art, iron will oxidize, that is, rust when exposed to moisture in the air. When iron oxidizes, the iron turns to any one of the various forms of ferrous oxide thereby causing the iron to disintegrate or degrade. Chromium is not ferrous and will not rust. Chromium is mixed with the iron to make it harder and also to make the blade shiny looking, hiding the rust.

It is known to those skilled in the art that all metals have specific relative electric potential such that when metals of different electric potential are in contact in the presence of water, an electric current can flow between the metals.

It is also known that when iron is honed to sharpness, such as to a razor's edge, electrons can be stripped off of the iron atoms on the surface of the razor blade. This can, thereby, create positively charged ferrous ions (for example: Fe²⁺ and Fe³⁺) disposed on the razor blade(s), which would then be available for a chemical reaction with air, water and any minerals or impurities that may be combined with the water. This results in oxidation of the iron and degradation of the cutting edge, thus diminishing the cutting edge's useful life. Oxidation of a razor blade can deteriorate the sharpness of the razor blade very quickly. When a cutting edge made of iron is used as a cutting tool, such as a razor blade being used in shaving, the act of moving the blade against the shaver's skin can also strip electrons from the surface of the blade, thereby contributing to creating ferrous ions available to react with water and oxidize the blade.

It is, therefore, desirable to provide an apparatus and method that can prevent or inhibit oxidization reactions occurring on the cutting edge so as to extend the useful life of the cutting edge and/or tool.

### SUMMARY

Described herein is an apparatus and method for extending the useful life of a cutting edge of a cutting edge tool. In one embodiment; the apparatus and method position a cutting edge in close proximity to a non-ferrous metal member that prevents or inhibits degradation or oxidation of the cutting edge.

In one embodiment, the apparatus comprises a non-ferrous metal member that prevents or inhibits oxidation, and a housing configured for positioning the metal member. In various embodiments of the invention, the metal member may be variously configured. In representative embodiments, the metal member is configured with projections or protrusions or the like. The housing holds the metal element and may be configured to promote positioning the cutting edge in proximity to the metal member.

In one embodiment, the method comprises providing a metal member, said metal member comprising one or more metal members that prevent or inhibit oxidation; and positioning a cutting edge in proximity to said one or more metal members.

The apparatus can comprise a metal member mounted in a housing adapted to receive the metal member and to support a cutting edge tool. As mentioned above, the metal member may be variously configured. In one embodiment, the metal member can be comprised of a non-ferrous metal. In a representative embodiment, the non-ferrous metal can comprise copper or a copper alloy. The metal member can further comprise a number of protrusions embossed or formed on the face of the metal member. One such embodiment, as illustrated in the Figures, comprises upward-facing three-dimensional protrusions. In one embodiment, each of these protrusions can comprise an apex. In a representative embodiment, the protrusions can be pyramid-shaped.

In one embodiment of the apparatus, the housing can be adapted to support a cutting edge tool such as a shaving razor. The metal member can be situated or disposed within the housing such that when the shaving razor is supported by the housing, the metal cutting edges of the razor blade(s) of the shaving razor are facing downwards, and the metal member is positioned beneath the cutting edges such that the three-dimensional protrusions of the metal member are facing upwards toward the cutting edges. When a shaving razor is supported by the housing, the cutting edges of the razor blade(s) can be suspended in proximity to the upward facing protrusions of the metal member. As used herein, “in proximity to” refers to a distance in the range of about 0.01 millimetres to 10 millimetres, including any increment therebetween. “In close proximity” includes a distance on the lower end of the scale, that is, from about 0.01 millimetres to about 3 millimetres, including any increment therebetween.

In another embodiment of the apparatus, a layer of non-ferrous metal can be disposed within the housing such that it is situated between the upward facing protrusions and the cutting edges of the razor blades. In one embodiment, the metal layer can be comprised of a non-ferrous metal. In a representative embodiment, the non-ferrous metal can comprise of copper or of a copper alloy. As well known to those skilled in the art, copper and copper alloys are excellent conductors of electricity due to its high electron mobility.

In yet another embodiment, the housing can enclose the metal member and the metal layer. In representative embodiments, the housing fully encloses the metal layer and partially encloses the metal member. In representative embodiments, the first metal member is positioned inside the housing such that a portion or all of the metal member is adjacent a port or window in the housing. Thus, the cutting edge tool may rest on the housing so that the cutting edge is in proximity to the first metal member through the port or window. In representative embodiments the port or window is open, e.g., a hole, but it is intended that the invention should not be limited thereby. The port may be configured as a lattice or include one or more cross pieces over the opening, as desired.

The housing can be made of a non-metallic material such as plastic or any other suitable material as known by those skilled in the art. In other embodiments, the housing of the apparatus can be adapted to support other cutting edge tools such as knife blades, scissors, knives and cutting shears in addition to shaving razors.

A method of extending the useful life of a cutting edge tool comprises placing the cutting edge tool in proximity to the metal member. For example, the cutting edge (or the tool) can be placed on top of the housing described above after the cutting edge tool has been used such that the cutting edge is suspended above the upward facing protrusions of the metal member. It is observed that placing a cutting edge tool, such as a shaving razor, on top of the housing described above after being used can extend the useful life of the cutting edges of the cutting edge tool.

The inventor believes that when a cutting edge, such as a shaving razor, is placed on the apparatus as described herein, the electric potential of the cutting edge, when in proximity to the non-ferrous metal member, can create an electric field extending from the cutting edge through the opening in the housing to the metal layer to the metal member, which can cause free electrons disposed on the surface on the metal member to be attracted to, and flow to, the positively charged ferrous ions disposed on the cutting edge. In so doing, at least some of the ferrous ions are “neutralized”, that is, become iron atoms with zero net charge, thereby reducing the number of ferrous ions available to react with water and thus oxidize the cutting edge. The inventor believes that the addition of the metal layer disposed between the cutting edge and the metal member aids in this effect by distributing the electric field evenly across its surface to expose the razor blade to a greater proportion of the electric field. The inventor also believes that this has the effect of desensitizing the magnetic properties of the blade so as to repel oxygen and oxygen ions from the blade tip to prevent or inhibit oxidation of the blade. By reducing oxidation and/or rust formation, the apparatus and method described herein can increase the useful life of the cutting edge of a cutting edge tool.

The inventor also believes that the three-dimensional protrusions on the metal member increases the surface area on the metal member and, hence, the number of electrons available as well as providing a means for directing electrons to the razor blade. The inventor also believes that the close proximity of the metal member to the cutting edge may also create an electrochemical micro-environment that can prevent or inhibit oxidation and/or rust, and otherwise changes the surface chemistry of the cutting edge so that degradation and/or rust/oxidation do not occur, and thereby increase the useful life of the cutting edge. The inventor, however, does not wish to be limited to this theory of operation as, for example, other forces of nature that the inventor is not aware of may be at work in preventing or inhibiting the oxidation of the razor blade when the shaving razor is placed on the apparatus as described herein.

In some embodiments, an apparatus is provided for preventing or inhibiting oxidation on a cutting edge of a cutting edge tool wherein the cutting edge comprises a plurality of metal ions further comprising an electrical charge, the apparatus comprising: a member made of non-ferrous metal having a plurality of upward facing three-dimensional protrusions, each three-dimensional protrusion comprising an apex, the member further comprising a plurality of electrons disposed on an upper surface thereof; and a housing adaptive for receiving said metal member, said housing adapted for supporting a cutting edge tool having a cutting edge wherein said cutting edge is in proximity to said protrusions when said cutting edge tool is supported by said housing, whereby electrons can flow from the metal member to the cutting edge to neutralize the electrical charge of the metal ions.

In some embodiments, a method is provided for preventing or inhibiting oxidation of a cutting edge of a cutting edge tool wherein the cutting edge comprises a plurality of metal ions further comprising an electrical charge, the method comprising the steps of: providing an apparatus comprising a member made of non-ferrous metal having a plurality of upward facing three-dimensional protrusions, each three-dimensional protrusion comprising an apex, the member further comprising a plurality of electrons disposed on an upper surface thereof; and placing said cutting edge in proximity of said metal member whereby electrons can flow from the metal member to the cutting edge to neutralize the electrical charge of the metal ions.

In some embodiments, an apparatus is provided for extending the useful life of a cutting edge tool wherein the cutting edge comprises a plurality of metal ions further comprising an electrical charge, the apparatus comprising: a member made of non-ferrous metal having a plurality of upward facing three-dimensional protrusions, each three-dimensional protrusion comprising an apex, the member further comprising a plurality of electrons disposed on an upper surface thereof; and a housing adaptive for receiving said metal member, said housing adapted for supporting a cutting edge tool having a cutting edge wherein said cutting edge is in proximity to said protrusions when said cutting edge tool is supported by said housing, whereby electrons can flow from the metal member to the cutting edge to neutralize the electrical charge of the metal ions.

### BRIEF DESCRIPTION OF THE DRAWINGS

FIG. 1 is a perspective view depicting a metal member that is disposed within an apparatus for supporting a cutting edge tool.

FIG. 2 is a cross-sectional elevational side view depicting an apparatus for supporting a shaving razor.

FIG. 3 is a perspective view depicting the apparatus of FIG. 2.

### DETAILED DESCRIPTION OF EMBODIMENTS

In one embodiment, the method described herein comprises the steps of providing at least one metal member that inhibits degradation and/or oxidation of a cutting edge of a cutting edge tool; and positioning the cutting edge in proximity to said metal member. Proper positioning the cutting edge may be accomplished by providing a housing or structure or the like configured to position the cutting edge in proximity to the at least one metal member.

In one embodiment, the apparatus described herein comprises at least one non-ferrous metal member disposed within a housing, said housing being configured to receive a cutting edge whereby the cutting edge communicates with or is in proximity to said metal member.

In representative embodiments, the cutting edge and/or the cutting edge tool is statically positioned on the housing in proximity to the metal member. That is, the tool or cutting edge does not need to be moving or oscillating.

As used herein, “metal member” refers to one or more metal plates, or strips, or the like; said metal being selected from any non-ferrous metal that reduces oxidation or degradation or rust formation. Exemplary metals include but are not limited to copper, brasses, bronzes and copper-nickel alloys. In representative embodiments, the metal member comprises copper or a copper alloy.

As used herein, the cutting edge refers to any edge that has been sharpened or honed or shaped to perform a pre-determined function, e.g., cutting and/or scraping task; or where an edge facilitates function of the tool, e.g., a screw driver or screwing bit. In representative embodiments, the cutting edge is a tool or forms a portion of a tool. Exemplary cutting edges include, but are not limited to a razor blade, a knife blade, scissors sharp or honed edges on any number of tools, e.g., cutting tools, garden tools, construction tools, etc. Accordingly, the cutting edge is or comprises a knife edge, e.g., a shaving blade or a knife. It has been found that the apparatus and method described herein is most useful or provides the most benefit for cutting edges that rust, e.g., steel or iron.

The inventor has also found that a function of the apparatus and method can be facilitated by providing a housing that promotes positioning the cutting edge in proximity to the metal member. A housing that positions the metal member in close proximity to the cutting edge may be used. A representative configuration is shown in the Figures.

As described above, proximity refers to the distance between the cutting edge and the metal member. Accordingly, any distance or configuration that reduces or eliminated oxidation on the surface of the cutting edge can be used. As noted above, the inventor has found that positioning the cutting edge in proximity to the metal member, that is, between 0.01 to 10 millimetres apart can extend a cutting edge's useful life.

As used herein, “extending the useful life” refers to preventing and/or inhibiting degradation on the surface of the cutting edge, e.g., preventing or inhibiting rust formation. Accordingly, the extension of useful life refers to retaining sharpness of the blade and/or preventing or reducing nicks or cuts when shaving.

In representative embodiments, the metal member can be configured or shaped with protrusions or the like that add surface area to the metal in the micro-environment where the cutting edge will be placed. The inventor intends that no particular shape or number of protrusions is necessary for the function of the apparatus and method described herein. However, the inventor has found that a series of protrusions such as those shown in the Figures facilitates extending the life of the cutting edge.

As used herein, a cutting edge may be a tool, or may be a part of or a component of a tool. Typical tools include but are not limited to razor blade, a knife blade, scissors sharp or honed edges on any number of tools, e.g., cutting tools, garden tools, construction tools, etc. In representative embodiments, the cutting edge comprises at least one razor blade and the tool is a manual shaving razor.

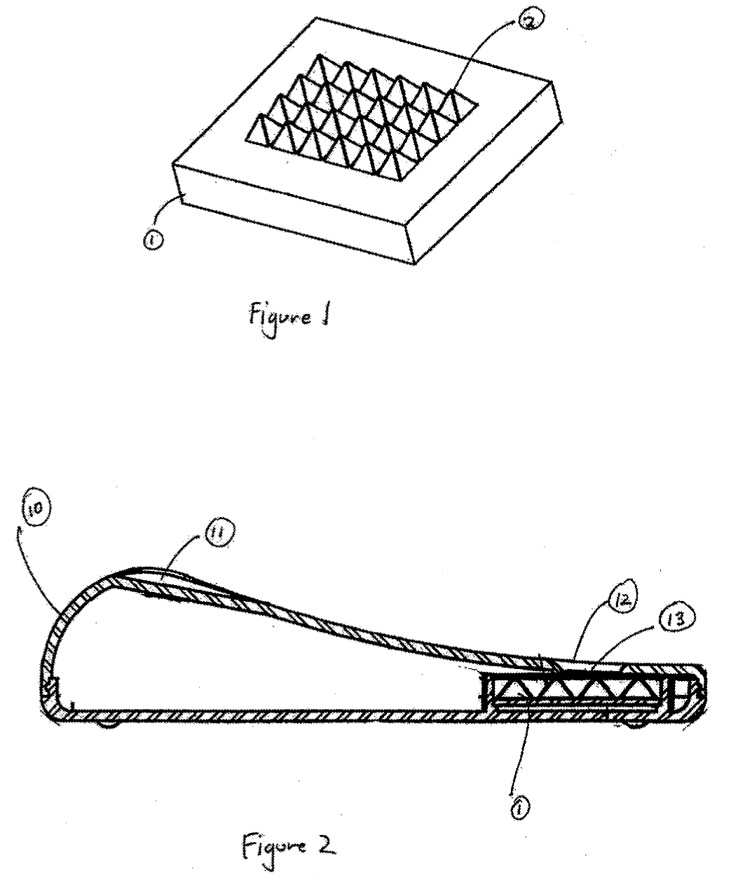

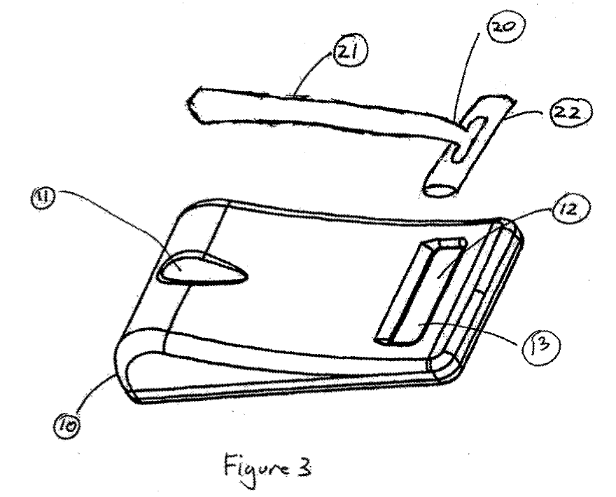

An apparatus for supporting a cutting edge tool and for extending the useful life of a cutting edge tool is shown in FIGS. 1 and 2. Metal member 1 is shown in FIG. 1. Metal member 1 can comprise of a plurality of upward facing protrusions disposed on the upper surface of metal member 1. In a representative embodiment, the upward facing protrusions can comprise pyramids 2. Pyramids 2 are three-dimensional protrusions and can be configured in a rectangular grid pattern. In one embodiment of the apparatus, pyramids 2 can be configured in a grid of 4 by 6 pyramids for a total of 24 although other grid configurations can be used.

Shown in FIG. 2 is a cross-sectional view of razor holder 10, comprising cradle 11, razor head receptacle 12 and metal member 1 and metal layer 13.

Shown in FIG. 3 is razor holder 10. Razor holder 10 can comprise cradle 11 for supporting the razor handle 21 of razor 20 and razor head receptacle 12 for receiving razor head 22 of razor 20. Razor head 22 can comprise one or more razor blades (not shown). In this embodiment, metal member 1 would lie (not shown in FIG. 3) under razor head receptacle 12 and metal layer 13. In one embodiment of the apparatus, metal member 1 and metal layer 13 can be made of a non-ferrous metal. In another embodiment, metal member 1 and metal layer 13 can be made of copper or of a copper alloy, such as bronze.

In operation, when razor 20 is set into razor holder 10, razor handle 21 would be placed in cradle 11 and razor head 22 would be set into razor head receptacle 12 where razor head 22 can rest on metal layer 13. In a typical razor 20, razor head 22 houses the razor blade(s) such that there is a gap between the razor blade(s) and metal layer 13 when razor head 22 is resting thereon. This gap is within the 0.01 to 10-millimetre distance to put the razor blade(s) in proximity to metal member 1, as described above. By doing so, the inventor believes that electrons can flow from the upper surface of metal member 1 through metal layer 13 to the razor blade(s) disposed in razor head 22, which can acquire a positive charge, either from the honing process when the blade(s) were manufactured or by the process of shaving itself. The electrons attracted to the razor blades can attach to ferrous ions disposed on the razor blade(s) to reduce the positive charge of the razor blade(s) and to reduce the number of ferrous ions that can react with water and/or any minerals or impurities in the water that result in oxidization of the razor blade(s) thereby preventing or inhibiting the oxidation thereof.

The inventor has observed that when a razor 20 is placed onto razor holder 10 after each time razor 20 has been used for shaving, the useful life of razor 20, which can normally be in the range of 5 to 10 shaves (1 to 2 weeks), can be extended from 3 months to 6 months or more. In other words, it is observed that razor 20 can be used for more shaves than what is normally expected from razor 20.

As an example, one user of the apparatus has reported to the inventor that he has used the apparatus with the same shaving razor blade for 10 months and that the blade is still sharp. Another user has reported to the inventor that he used to get only 6 to 7 shaves from his Gillette MACH3® razor before having to change cartridges; now, with using the apparatus, he has used the same cartridge for 12 months and still getting great shaves from it. Yet another user has reported to the inventor that he has the apparatus with his Gillette MACH3® razor for over 10 weeks and that the razor is ‘still going strong’.

Although some embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

What is claimed is:

1. An apparatus for extending the useful life of a cutting edge comprising:
a metal member positioned in a housing, said metal member comprising one or more metals that reduce or inhibit oxidation; and
a housing, configured to position the cutting edge in proximity to the metal member;
whereby positioning the cutting edge in proximity to the metal member reduces or inhibits degradation of the cutting edge, thereby extending the useful life of the cutting edge.

2. A method for extending the life of a cutting edge tool comprising providing a metal member in a housing, positioning a cutting edge on the housing in proximity to the metal member, and allowing the metal member to reduce or eliminate degradation of the cutting edge, thereby extending the life of the cutting edge.

3. An apparatus for preventing or inhibiting oxidation on a cutting edge of a cutting edge tool wherein the cutting edge comprises a plurality of metal ions further comprising an electrical charge, the apparatus comprising:
a) a member made of non-ferrous metal having a plurality of upward facing three-dimensional protrusions, each three-dimensional protrusion comprising an apex, the member further comprising a plurality of electrons disposed on an upper surface thereof; and
b) a housing adaptive for receiving said metal member, said housing adapted for supporting a cutting edge tool having a cutting edge wherein said cutting edge is in proximity to said protrusions when said cutting edge tool is supported by said housing, whereby electrons can flow from the metal member to the cutting edge to neutralize the electrical charge of the metal ions.

4. The apparatus as set forth in claim 3 wherein said cutting edge tool is selected from the group consisting of shaving razors, knife blades, scissors, knives and cutting shears.

5. The apparatus as set forth in claim 3 wherein said metal member comprises copper or a copper alloy.

6. The apparatus as set forth in claim 3 wherein said cutting edge is suspended above said protrusions by a distance in the range of about 0.01 millimetres to 10 millimetres.

7. The apparatus as set forth in claim 3 wherein said housing further comprises a layer of non-ferrous metal disposed between said protrusions and said cutting edge when said cutting edge tool is supported by said housing.

8. The apparatus as set forth in claim 7 wherein said layer of metal comprises copper or a copper alloy.

9. A method for preventing or inhibiting oxidation of a cutting edge of a cutting edge tool wherein the cutting edge comprises a plurality of metal ions further comprising an electrical charge, the method comprising the steps of:
a) providing an apparatus comprising a member made of non-ferrous metal having a plurality of upward facing three-dimensional protrusions, each three-dimensional protrusion comprising an apex, the member further comprising a plurality of electrons disposed on an upper surface thereof; and
b) placing said cutting edge in proximity to said protrusions whereby electrons can flow from the metal member to the cutting edge to neutralize the electrical charge of the metal ions.

10. The method as set forth in claim 9 wherein said cutting edge tool is selected from the group consisting of shaving razors, knife blades, scissors, knives and cutting shears.

11. The method as set forth in claim 9 wherein said metal member comprises copper or a copper alloy.

12. The method as set forth in claim 9 wherein said cutting edge is suspended above said protrusions by a distance in the range of about 0.01 millimetres to 10 millimetres.

13. The method as set forth in claim 9 wherein said housing further comprises a layer of non-ferrous metal disposed between said protrusions and said cutting edge when said cutting edge tool is supported by said housing.

14. The method as set forth in claim 13 wherein said layer of metal comprises copper or a copper alloy.

15. An apparatus for extending the useful life of a cutting edge tool wherein the cutting edge comprises a plurality of metal ions further comprising an electrical charge, the apparatus comprising:
a) a member made of non-ferrous metal having a plurality of upward facing three-dimensional protrusions, each three-dimensional protrusion comprising an apex, the member further comprising a plurality of electrons disposed on an upper surface thereof; and
b) a housing adaptive for receiving said metal member, said housing adapted for supporting a cutting edge tool having a cutting edge wherein said cutting edge is in proximity to said protrusions when said cutting edge tool is supported by said housing, whereby electrons can flow from the metal member to the cutting edge to neutralize the electrical charge of the metal ions.

16. The apparatus as set forth in claim 15 whereby said cutting edge tool is selected from the group consisting of shaving razors, knife blades, scissors, knives and cutting shears.

17. The apparatus as set forth in claim 15 whereby said metal member comprises copper or a copper alloy.

18. The apparatus as set forth in claim 15 wherein said cutting edge is suspended above said protrusions by a distance in the range of about 0.01 millimetres to 10 millimetres.

19. The apparatus as set forth in claim 15 wherein said housing further comprises a layer of non-ferrous metal disposed between said protrusions and said cutting edge when said cutting edge tool is supported by said housing.

20. The apparatus as set forth in claim 19 wherein said layer of metal comprises copper or a copper alloy.
